(19) United States
(12) Patent Application Publication
(10) Pub. No.: US 2010/0107169 A1
(43) Pub. Date: Apr. 29, 2010

(54) PERIODICAL TASK EXECUTION APPARATUS, PERIODICAL TASK EXECUTION METHOD, AND STORAGE MEDIUM

(75) Inventor: Tatsuaki Watanabe, Kanagawa (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/502,534

(22) Filed: Jul. 14, 2009

(30) Foreign Application Priority Data
Oct. 24, 2008 (JP) 2008-274431

(51) Int. Cl. G06F 9/48

(52) U.S. Cl. 718/103

(57) ABSTRACT

A periodical task execution apparatus executes one or more periodical tasks to be executed in a predetermined sequence, including a comparison section configured to compare, when an activation request for any one of the one or more periodical tasks is made, priority of a task 1 executing when the activation request is made and priority of a periodical task specified by the activation request; a context register switching section configured to switch a register to be referred to for context to a periodical task context register if it is found as a result of the comparison that the priority of the periodical task is higher than the priority of the executing task; and a context setting section configured to load the periodical task context register with context of a periodical task to be executed next according to the predetermined sequence when execution of the periodical task is ended.

### CROSS REFERENCE TO RELATED APPLICATION

This application is based upon and claims the benefit of priority from the prior Japanese Patent Application No. 2008-274431 filed in Japan on Oct. 24, 2008, the entire contents of which are incorporated herein by reference.

### BACKGROUND OF THE INVENTION

1. Field of the Invention

The present invention relates to a periodical task execution apparatus, periodical task execution method, and storage medium, and more particularly, to a periodical task execution apparatus, periodical task execution method, and storage medium which execute periodical tasks to be executed in a predetermined sequence.

2. Description of Related Art

Conventionally, computer operating systems (hereinafter abbreviated to OSes) include real-time OSes, which are used widely.

Generally, with a real-time OS, an interrupt handler executes application programs to be executed in real time (hereinafter referred to as a real-time applications or real-time tasks), by interrupt handling, for example, at predetermined intervals.

Specifically, the interrupt handler is started periodically, for example, by a hardware timer or the like. To start the interrupt handler, a scheduler which manages task execution performs context switching and dispatching processes, and consequently the interrupt handler is executed.

The interrupt handler thus executed makes a request to activate a real-time application to be executed periodically.

The interrupt handler finishes processing after making the request to activate the real-time application and the scheduler which manages task execution resumes processing. For example, Japanese Patent Application Laid-Open Publication No. 2001-75820 discloses a technique in which a scheduler determines tasks which are to be executed and performs context switching and dispatching processes, based on predetermined scheduling rules.

That is, the scheduler determines, based on priorities, whether a task to be executed next is a real-time application or another task. Then, the task determined to be executed next is executed. The real-time OS repeats the above processes and thereby executes various tasks including real-time applications.

However, since real-time applications are activated by the interrupt handler, there is overhead for activation of the interrupt handler and execution of the scheduler after execution of the interrupt handler. That is, to execute a real-time application, the real-time OS requires overhead for at least two context switching processes and a dispatching process.

Such overhead is not desirable from the standpoint of execution performance of real-time applications. For example, since functions and behavior of various programs have to be verified during the design of the programs, it is inherently desirable that there is no overhead such as described above. Much overhead means that there are many obstacles to sequential execution of software. From the standpoint of software verification, this means that the software is increasingly forced to wait for execution, which can result in deterioration of software quality itself.

### BRIEF SUMMARY OF THE INVENTION

According to one aspect of the present invention, there is provided a periodical task execution apparatus which executes one or more periodical tasks to be executed in a predetermined sequence, the periodical task execution apparatus including: a comparison section configured to compare, when an activation request for any one of the one or more periodical tasks is made, priority of a task executing when the activation request is made and priority of a periodical task specified by the activation request; a context register switching section configured to switch a register to be referred to for context to a periodical task context register which stores context of the periodical task specified by the activation request if it is found as a result of the comparison made by the comparison section that the priority of the periodical task specified by the activation request is higher than the priority of the executing task; and a context setting section configured to load the periodical task context register with context of a periodical task to be executed next according to the predetermined sequence when execution of the periodical task specified by the activation request is ended.

### BRIEF DESCRIPTION OF THE DRAWINGS

FIG. 1 is a schematic block diagram showing a configuration of a computer system according to an embodiment of the present invention;

FIG. 2 is a diagram illustrating an example of a periodical sequence according to the embodiment of the present invention;

FIG. 3 is a diagram illustrating another example of a periodical sequence according to the embodiment of the present invention;

FIG. 4 is a diagram showing a configuration of a register group 11a installed on hardware, according to the embodiment of the present invention;

FIG. 5 is an activity diagram showing task switching activities in the case of normal tasks, according to the embodiment of the present invention;

FIG. 6 is an activity diagram showing task switching activities in the case of a periodical task, according to the embodiment of the present invention;

FIG. 7 is a diagram illustrating a relationship between registers and context, according to the embodiment of the present invention;

FIG. 8 is a diagram illustrating operation of a computer system during execution of a periodical task, according to the embodiment of the present invention;

FIG. 9 is a block diagram showing an example of a circuit used to give an instruction to start executing the periodical task in FIG. 6; and

FIG. 10 is a block diagram showing an example of a circuit used to determine an end of execution of the periodical task in FIG. 6.

### DETAILED DESCRIPTION OF THE INVENTION

An embodiment of the present invention will be described below with reference to the drawings.

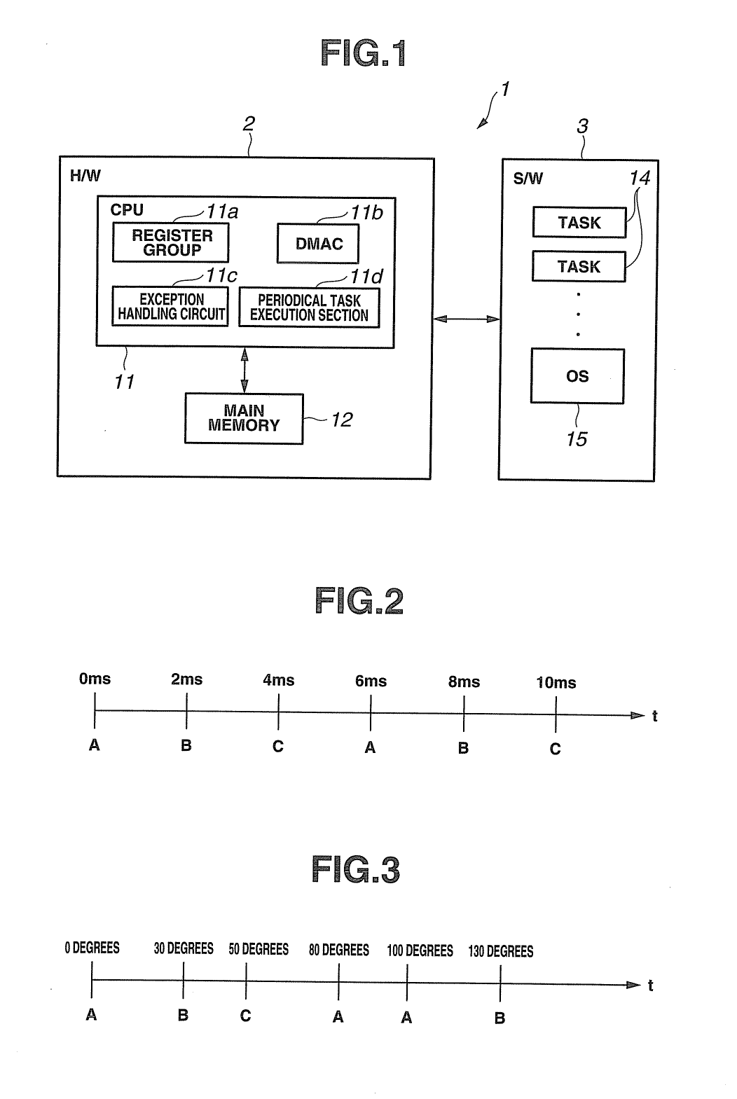

First, a configuration of a computer system according to the present embodiment will be described below with reference to FIG. 1. FIG. 1 is a schematic block diagram showing the configuration of the computer system according to the present embodiment.

The computer system 1 includes hardware 2 and software 3. The hardware 2 includes a central processing unit (hereinafter referred to as a CPU) 11 and a main memory 12. The hardware 2 is a semiconductor device such as a semiconductor chip. The CPU 11 includes a register group 11a which holds various data such as context, a DMA controller (also referred to as a DMAC) 11b which controls DMA operation, and an exception handling circuit 11c which performs various types of exception handling as well as an arithmetic circuit such as an ALU (not shown). The hardware 2 includes various other circuits which, however, are omitted in FIG. 1.

The software 3 includes multiple tasks 14 and an OS 15, where each of the tasks 14 constitutes an application program which performs predetermined processing and the OS 15 is a real-time OS. The software 3 includes various other software programs which, however, are omitted in FIG. 1. The multiple tasks 14 include one or more periodical tasks (described later) in addition to normal tasks. The multiple tasks 14 are loaded into the main memory 12 under the control of the OS 15 and executed by the CPU 11. Also, the software 3 includes a normal interrupt handler which, however, is not illustrated.

According to the present embodiment, a periodical task execution section 11d (described later) is implemented by a software program. The periodical task execution section 11d is loaded into the main memory 12 and executed by the CPU 11, but illustrated in FIG. 1 as being included in the CPU 11 for clarity of explanation.

The computer system 1 serves as a periodical task execution apparatus which executes periodical tasks. The periodical task execution section 11d is a program which makes the computer system 1 execute the periodical tasks. Although according to the present embodiment, the periodical task execution section 11d is described as being a software program, part or all of the periodical task execution section 11d may be implemented by hardware. In that case, the periodical task execution section 11d serves as the periodical task execution apparatus.

Next, the periodical task according to the present embodiment will be described.

The periodical task according to the present embodiment is a task driven with a predetermined timing: for example, at a predetermined time or by a predetermined event (such as detection of a location or angle of a member).

FIGS. 2 and 3 are diagrams illustrating examples of a periodical sequence. Regarding tasks driven at a predetermined time, FIG. 2 shows a periodical sequence in which periodical tasks are executed in 2-ms (millisecond) periods. Thus, the periodical tasks are executed at 2-ms intervals. Regarding tasks driven by a predetermined event, FIG. 3 shows a periodical sequence in which tasks are executed, for example, when an angle of a rotating member as detected by a sensor reaches predetermined values.

That is, the periodical task is executed in a predetermined periodical sequence. The periodical sequence is a sequence in which an execution sequence of a periodical task or each of multiple periodical tasks is predetermined respectively.

For example, among the multiple tasks 14, the periodical sequence may be such that one periodical task A will be executed at predetermined time intervals or such that periodical tasks A, B, and C will be executed in a predetermined order.

Specifically, FIG. 2 shows a sequence in which tasks A, B, and C are executed at 2-ms intervals, i.e., A, B, C, A, B, C, A, B, C, . . . : task A is executed at 0 ms (zero milliseconds), task B is executed at 2 ms, task C is executed at 4 ms, task A is executed at 6 ms, and task B is executed at 8 ms, and so on.

FIG. 3 shows a sequence in which predetermined tasks are executed upon occurrence of predetermined events: task A is executed when a detected angle of a rotating member is 0 degrees, task B is executed at a detected angle of 30 degrees, task C is executed at 50 degrees, task A is executed at 80 and 100 degrees, task B is executed at 130 degrees, and so on.

Thus, the sequence of periodical tasks is determined in advance.

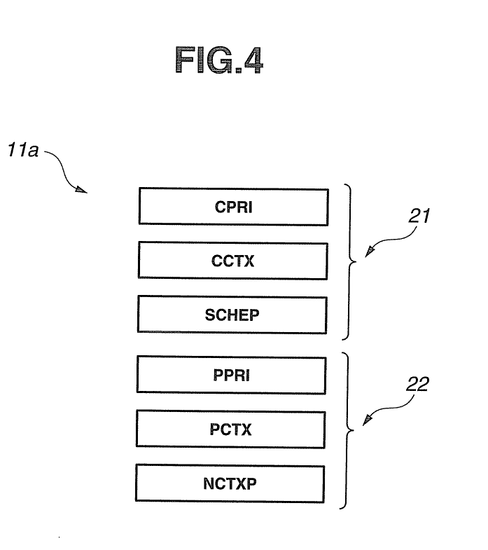

Next, various registers included in the register group 11a will be described. FIG. 4 is a diagram showing a configuration of the register group 11a installed on the hardware 2.

The register group 11a includes a current task priority register (hereinafter abbreviated to CPRI, which stands for Current task PRIority register), a register (hereinafter abbreviated to CCTX) which stores context of normal tasks other than periodical tasks, a scheduler pointer register (hereinafter abbreviated to SCHEP, which stands for SCHEduler Pointer), a periodical task priority register (hereinafter abbreviated to PPRI, which stands for Periodical task PRIority register), a periodical context register (hereinafter abbreviated to PCTX, which stands for Periodical ConTeXt), and next periodical context pointer register (hereinafter abbreviated to NCTXP, which stands for Next periodical ConTeXt Pointer). The three registers—PPRI, PCTX, NCTXP—make up a register group for periodical execution.

The CPRI, i.e., the current task priority register, stores the priority of a currently started task, i.e., an executing task.

The SCHEP, i.e., the scheduler pointer register, stores an address which represents the starting position of a scheduler.

The PPRI, i.e., the periodical task priority register, stores the priority of a periodical task to be started up next.

The PCTX, i.e., the periodical context register, has the same configuration as the CCTX register which stores normal task context. That is, the PCTX is a register group which stores task context such as a program counter (PC) and stack pointer (SP). Incidentally, the CCTX stores context of tasks other than periodical tasks.

The NCTXP, i.e., the next periodical context pointer register, stores a storage address of the context of the task to be started up next.

As described later, these register groups are divided into a register group 21 used during execution of normal tasks and a periodical task register group 22 used during execution of periodical tasks. The register group 21 includes the CPRI, CCTX, and SCHEP while the periodical task register group 22 includes the PPRI, PCTX, and NCTXP.

Incidentally, the registers in the periodical task register group 22 may be those dedicated to periodical tasks. Alternatively, part of conventional registers may be used for periodical tasks.

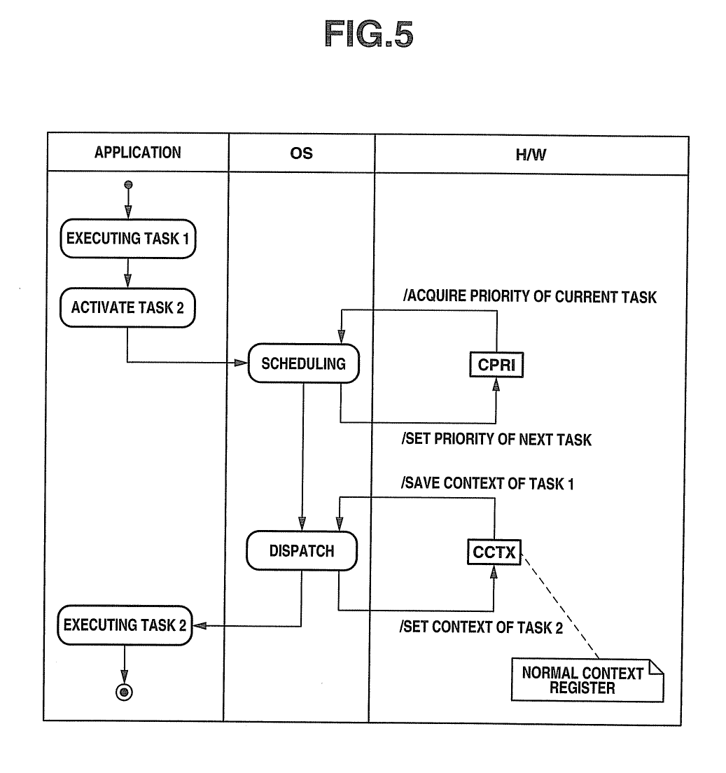

First, description will be given of a flow of processing performed when only normal tasks other than periodical tasks are executed. FIG. 5 is an activity diagram showing task switching activities in the case of normal tasks. Processes for registers in FIG. 5 are performed by a normal scheduler (not shown) and the like.

As shown in FIG. 5, if task 2 which is a normal task is activated during execution of task 1 which is a normal task of an application program, a scheduler of a real time OS performs scheduling. In the scheduling, the scheduler acquires priority information of task 1 which is a currently executing task (hereinafter referred to as the current task) from the CPRI, compares priorities between task 1 and task 2, and determines the task which is to be executed next. Once the task to be executed next (hereinafter referred to as the next task) is determined, the priority of the next task is set in the CPRI and the next task is dispatched.

If task 2 is determined to be the next task as a result of the scheduling, context of task 1 is saved from the CCTX which is a normal context register to a predetermined storage area in the main memory 12 and context of task 2 is loaded into the CCTX. Then, the next task 2 is being executed.

In this way, tasks other than periodical tasks are switched using conventional register groups such as the CPRI and CCTX.

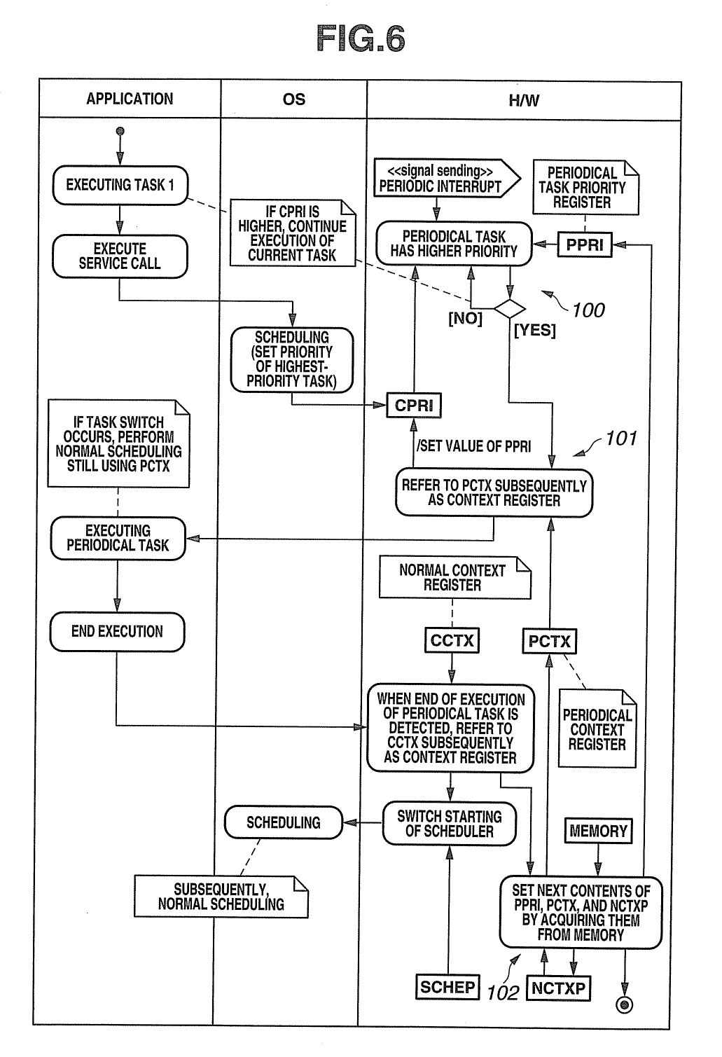

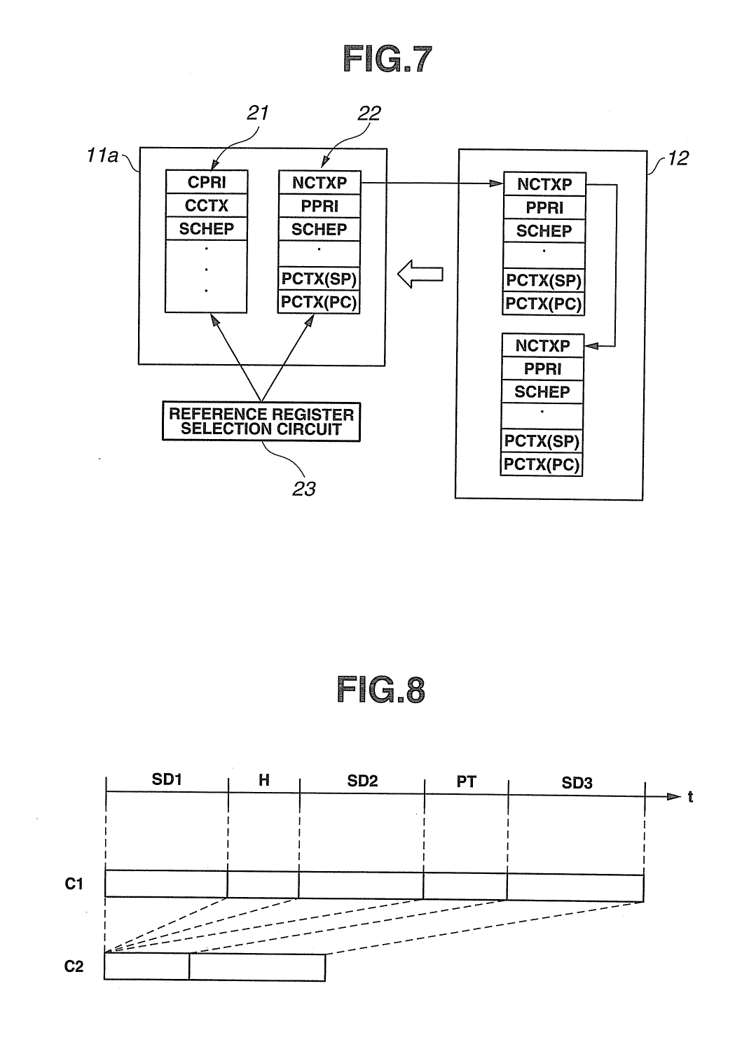

Next, description will be given of a flow of processing performed when periodical tasks are executed. FIG. 6 is an activity diagram showing task switching activities in the case of a periodical task. FIG. 7 is a diagram illustrating a relationship between registers and context.

FIG. 6 shows a case in which a normal task is executed first, a periodical task is executed next, and then a normal task is started up again. Processes for registers in FIG. 6 are performed by the periodical task execution section 11d.

During execution of normal task 1 of an application program, a periodical task is executed when any necessary service call occurs. If a request to execute a periodical task is made during execution of task 1, scheduling is performed. Suppose, for example, an interrupt occurs during execution of normal task 1, requesting execution of periodical task A. Incidentally, it is assumed that the priority of periodical task A to be executed next has been loaded in advance and stored in PPRI.

The OS scheduler compares priorities between task 1 and periodical task A with reference to the CPRI and PPRI and thereby determines the task which is to be executed next. The scheduler performs scheduling in such a way that the highest-priority task will be executed. If the priority of periodical task A is not higher than the priority of task 1 (i.e., the priority read out of the CPRI is higher than the priority read out of the PPRI), the determination results in a No answer, and consequently, execution of the current task, i.e., task 1, is continued.

Incidentally, when the priority of periodical task A is equal to the priority of task 1, periodical task A may be executed by interrupting execution of task 1.

If the priority of periodical task A is higher than the priority of task 1, the determination results in a Yes answer and the value of PPRI which contains the priority of the next task, i.e., periodical task A, is loaded into the CPRI. Consequently, the value of CPRI matches the value of PPRI.

As shown in FIG. 7 and described above, the register group 11a includes the periodical task register group 22 used during execution of periodical tasks in addition to the register group 21 used during execution of normal tasks, where the register group 21 in turn includes the CPRI, CCTX, and SCHEP while the periodical task register group 22 includes the PPRI, PCTX, and NCTXP.

If the current task of the application program is a normal task, the register group 21 is used as a context register to be referred to.

On the other hand, if the current task of the application program is a periodical task, the periodical task register group 22 is used as a context register to be referred to.

As shown in FIG. 7, a selection as to which of the register groups 21 and 22 will be used as the context register is made by a reference register selection circuit 23 based on the result of determination described above. An instruction to select one of the register groups 21 and 22 is given to the reference register selection circuit 23 by the periodical task execution section 11d. The reference register selection circuit 23 is, for example, a predetermined register circuit which holds data representing the selection.

As described above, when a predetermined periodic interrupt occurs for a periodical task, i.e., when there is a request to activate a periodical task, a comparison section 100 of the periodical task execution section 11d compares the priority (PPRI) of periodical task A requested to be activated with the priority (CPRI) of the current task 1.

The comparison section 100 is a processing section which, when there is an activation request for any periodical task, compares priorities between the task executing when the activation request is made and the task requested to be activated.

If the priority of periodical task A is higher, a context register switching section 101 switches the context register to be referred to. Consequently, the periodical context register PCTX is selected in order to be used as the task context.

The context register switching section 101 is a processing section which switches the register to be referred to for context to the periodical task context register (PCTX) when the priority of the periodical task specified by an activation request is higher than the priority of an executing task, where the periodical task context register (PCTX) stores the periodical task specified by the activation request.

When the priority of the current task 1 is higher than the priority of periodical task A, the current task 1 continues to be executed, and activation of periodical task A is listed as pending by task scheduling until a switch to a task lower in priority than the PPRI takes place.

When the priority of periodical task A is higher than the priority of the current task 1, periodical task A automatically enters an execution state because the register to be referred to for context is switched to the periodical task register group 22 and consequently the program counter PCTX (PC) is referred to.

Incidentally, a task switch may occur during execution of periodical task A. If a task switch occurs, normal scheduling is performed still using the PCTX. That is, normal scheduling is performed assuming the use of the PCTX. Thus, if there is a task higher in priority than periodical task A, the task higher in priority is executed.

Thus, even during execution of a periodical task, it is designed such that task switch requests can be accepted. Regarding relationships between the periodical task and the task requested to be executed, there can be a case in which a task lower in priority than the executing periodical task is requested to be executed and a case in which a task higher in priority than the executing periodical task is requested to be executed. In the former case, although scheduling is performed, the rest is the same as when there is no task execution request because the periodical task continues to be executed. In the latter case, the requested task is started up as a result of scheduling. In this case, context is switched as in the case of a switch between normal tasks. Since the PCTX continues to be used as a context register, the task, the OS, and the hardware only need to perform the same processes as in the case of a switch between normal tasks.

Incidentally, a periodical task timeout exception may occur during execution of a periodical task. A periodical task timeout exception can occur when an interrupt to start up the next periodical task is accepted before processing of the periodical task ends. Predetermined exception handling is designed to be performed when a periodical task timeout exception occurs. The periodical task execution section 11d includes an exception handling section which performs the predetermined exception handling. When a periodical task timeout exception occurs, the exception handling section determines, for example, whether to continue execution of the current task or switch to processing of the next task.

When the execution of periodical task A ends, preparations are made to activate the next periodical task. Specifically, values of the periodical task register group 22 (including the PPRI, the PCTX, and the NCTXP) are updated. The NCTXP in the periodical task register group 22 stores the storage address of the context of the periodical task to be executed next according to a predetermined sequence. Therefore, with reference to the NCTXP, a context setting section 102 of the periodical task execution section 11d updates the NCTXP, the PPRI, and the PCTX in the periodical task register group 22 all at once using DMA.

The context setting section 102 is a processing section which, when the execution of a periodical task requested to be activated is ended, loads the periodical task context register with context of a periodical task to be executed next according to a predetermined sequence.

More specifically, when an end of execution of periodical task A is detected, the periodical task execution section 11d makes the reference register selection circuit 23 select the register group 21 and sets the CCTX as a context register to be referred to subsequently.

Then, the context setting section 102 saves the context of periodical task A which has ended execution in an appropriate predetermined storage area of the main memory 12, reads context of periodical task B to be executed next out of an appropriate predetermined storage area of the main memory 12, and loads the periodical task register group 22 with the context of periodical task B.

When the execution of periodical task A ends, the NCTXP of the periodical task register group 22 stores the storage address of the context of the periodical task to be executed next, for example, the context of periodical task B. Thus, with reference to the NCTXP, the context setting section 102 can read the context of the next periodical task—i.e., contents of the PPRI, PCTX, and NCTXP—out of the main memory 12 using DMA and load the context into the periodical task register group 22.

In the periodical sequence in FIG. 2, the periodical tasks to be executed next are determined in advance as follows: after task A comes task B, after task B comes task C, after task C comes task A, and so on. In the periodical sequence in FIG. 3, the periodical tasks to be executed next are determined in advance as follows: A, B, C, A, A, B, and so on.

As shown in FIG. 7, context data of multiple periodical tasks are stored respectively in appropriate predetermined storage areas of the main memory 12. Each set of context data includes NCTXP data. The NCTXP stores pointer data to the context of the periodical task to be executed next to the given periodical task, where the next periodical task is preset by the periodical sequence. In the example of FIG. 2, since task B is executed next to periodical task A, pointer data to the context of periodical task B is stored in the NCTXP among the context of task A.

As shown in FIG. 7, the context data of periodical task A includes the NCTXP data, which is the pointer data to the context of the next periodical task B. Thus, when the execution of periodical task A ends, the periodical task execution section 1Id acquires the context of periodical task B from the main memory 12 based on the pointer data to the context of periodical task B using DMA and loads the context of periodical task B into the periodical task register group 22, where the pointer data is indicated by the NCTXP data among the context of periodical task A. The context of periodical task B is thus loaded into the periodical task register group 22, and the NCTXP of the periodical task register group 22 now contains a value of a context pointer of periodical task C to be executed next to periodical task B (in the case of FIG. 2).

When the above processes end, the SCHEP is referred to, the program counter of the CPU 11 is switched to a starting address of the scheduler, and scheduling is performed again. The scheduling is performed by comparing a current state with a state in which an interrupt is assumed to have occurred during execution of the task before the switch.

The context of periodical task B to be executed next is contained in the periodical task register group 22. Thus, when periodical task B is executed as a result of a next periodic interrupt, task B can be executed without the overhead of a scheduler dispatching process or interrupt handling process conventionally needed in such a case.

FIG. 8 is a diagram illustrating operation of the computer system 1 during execution of a periodical task, according to the present embodiment. FIG. 8 shows execution of processes in time sequence.

In FIG. 8, case C1 shows conventional operation during execution of a periodical task. In case C1, when a periodical task is requested to be executed, three processes are performed: a scheduling & dispatching process SD1, interrupt handling process H needed to activate the periodical task, and scheduling & dispatching process SD2. Subsequently, a periodical task processing process PT is performed, and a scheduling & dispatching process SD3 is performed after the end of the periodical task processing process PT.

In contrast, according to the present embodiment, as shown in case C2, the periodical task processing process PT is started directly without the three processes (SD1, H, and SD2) described above.

Thus, the present embodiment, which can execute the periodical task without the overhead described above, can reduce execution time.

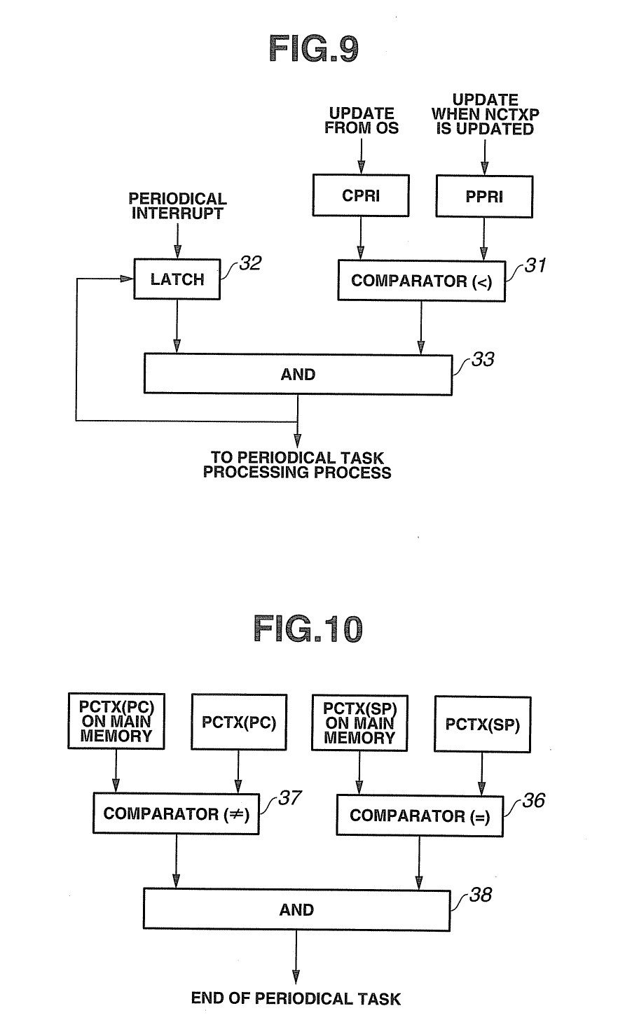

In the example described above, various processes of the periodical task execution section 11d are implemented by software, but part of the processes may be implemented by hardware. FIG. 9 is a block diagram showing an example of a circuit used to give an instruction to start executing the periodical task in FIG. 6.

The CPRI and PPMI in the register group 11a store updated data from the OS and updated data produced when the NCTXP is updated, respectively. The CPRI represents the priority of the task executing on the real-time OS. The PPRI represents the priority of the task expected to be executed next and started up by a periodical interrupt. A comparator 31 compares data between the CPRI and the PPRI. When the PPRI is higher in priority than the CPMJ, the comparator 31 outputs “1”.

On the other hand, when an interrupt occurs to execute a periodical task, a periodical interrupt signal which indicates the interrupt is inputted and latched in a latch circuit 32. When a periodical interrupt signal is latched, the latch circuit 32 outputs “1”.

When both comparator 31 and latch circuit 32 output “1”, an AND circuit 33 outputs a signal instructing that execution of the periodical task be started and resets the latch circuit 32.

That is, when a periodical interrupt signal is generated, if the priority (PPRI) of the periodical task to be executed next is higher than the priority (CPRI) of the currently running task, transition to a periodical task processing process takes place.

As described above, the comparison and determination made by the comparison section 100, i.e., the determination regarding the transition to a periodical task can be implemented by hardware such as shown in FIG. 9.

On the other hand, if the PPRI is lower than the CPRI, even if a periodical interrupt occurs, processing of the current task continues without transition to processing of the periodical task. However, if a periodical interrupt occurs again during the periodical task processing process, a periodical task timeout exception occurs.

FIG. 10 is a block diagram showing an example of a circuit used to determine an end of execution of the periodical task in FIG. 6.

Stack pointer SP (PCTX(SP)) data of the PCTX in the periodical task register group 22 and corresponding (PCTX(SP)) data on the main memory 12 are inputted in a comparator 36.

Also, program counter PC (PCTX(PC)) data of the PCTX in the periodical task register group 22 and corresponding (PCTX(PC)) data on the main memory 12 are inputted in a comparator 37.

When PCTX(SP) on the main memory 12 matches PCTX(SP) in the periodical task register group 22, the comparator 36 outputs “1”. A value of PCTX(SP) in the periodical task register group 22 changes as various functions are executed. When a value of PCTX(SP) in the periodical task register group 22 and a value of the first stack pointer PCTX(SP) on the main memory 12 are different, it means that a task is executing. When the values match, the stack pointer returns to original position, meaning that execution of the various functions has ended.

The comparator 37 outputs “1” when PCTX(SP) on the main memory 12 and PCTX(SP) in the periodical task register group 22 are not equal. PCTX(SP) on the main memory 12 remains unchanged, but PCTX(SP) in the periodical task register group 22 changes because a value of the program counter is incremented as a task is executed.

When both comparators 36 and 37 output “1”, an AND circuit 38 outputs an end-of-periodical-task detection signal.

That is, by detecting execution of a periodical task based on a change in the program counter and by detecting, based on coincidence in the stack pointer data, that the execution of the periodical task has ended, a determination circuit in FIG. 10 can determine the end of the periodical task.

Thus, determination regarding the end of execution of a periodical task can be implemented by a hardware circuit such as shown in FIG. 10.

Incidentally, to detect the end of a periodical task, an instruction to output a signal indicating an end of the periodical task may be included in a program of the periodical task so that the end of the periodical task can be detected upon output of the signal.

That is, although in FIG. 10, the register PC of the program counter and the register SP of the stack pointer are compared by a comparator, the end of a periodical task may be announced explicitly by software, for example, by including an instruction which indicates an end of the periodical task in the periodical task or by writing a predetermined value which indicates an end in a predetermined register.

Such a software-based method provides more choices of hardware implementation methods and gives variety to methods for generating and announcing a timing to end the periodical task.

Thus, the present embodiment, which can execute the periodical task without the conventional overhead of activating an interrupt handler or executing a scheduler before and after execution of the interrupt handler, improves real-time applications' execution performance and ease of verification. Therefore, the present embodiment eliminates the need for a conventional handler for periodical execution, making it possible to implement a periodical task execution apparatus with reduced overhead for activation of the periodical task.

Incidentally, although there is only one periodical task sequence in the embodiment described above, there are sometimes multiple periodical sequences. In such a case, if the periodical task register group 22 (PPRI, PCTX, and NCTXP) and periodical task timeout exception handling circuit are provided for each periodical task sequence, each of the periodical task sequences can be handled in the same manner as when there is only one periodical task sequence.

In this case, there can be not only conflicts between a normal task and periodical task, but also conflicts between periodical tasks. However, since a periodical task is activated only when the periodical task has a higher priority than CPRI, the conflicts between periodical tasks can be handled in the same manner as the conflicts with a normal task.

Thus, for example, in a system in which different periodical task sequences such as a timer-driven periodical task sequence and event-driven periodical task sequence coexist, where events are constituted, for example, of angles of a rotating body or the like, execution control of the periodical tasks can be performed in the same manner as described above.

Besides, the periodical task execution control according to the embodiment described above can also be performed in a system in which only one or more periodical tasks are executed on a processor without any normal task.

Although normal event-driven tasks or other normal tasks are mixed in the embodiment described above, the periodical task execution control described above can also be applied to a software architecture which does not contain any normal task (i.e., an architecture which includes only periodical task sequences).

For example, a process corresponding to a predetermined event may be performed by detecting the predetermined event by polling from a periodical task. This makes it possible to build a power-saving computer system which changes a microprocessor into a so-called sleep mode when no periodical task is running. In that case, the microprocessor changes to normal mode when a periodical interrupt occurs.

Also, if periodical interrupts are timer-based or otherwise predictable, by changing a microprocessor's mode into normal mode before an actual periodical interrupt occurs, it is possible to build a system which reduces overhead caused by the microprocessor's mode change.

Furthermore, in the embodiment described above, it is assumed that determination as to whether to continue processing or change to a next process upon occurrence of a periodical task timeout exception is made by software. Also, subsequent processes are assumed to be performed by software. That is, in the case of a periodical task timeout exception, the software performs an appropriate process to handle the exception.

However, in the case of a one-time overlap, there are cases in which it is desired or acceptable to execute the current periodical task to the end and then detect and execute a next periodical interrupt anew.

Therefore, the system may be configured such that an exception will be avoided only once by suspending an exception factor and that after the currently executing periodical task ends, the exception handling described above will be carried out when a periodical task timeout exception occurs.

Furthermore, although in the embodiment described above, periodical task registers are updated by DMA or the like from the main memory 12, if there are not many periodical tasks in a periodical sequence, a periodical task register may be provided for each periodical task and the register used may be changed in each period. This configuration can reduce the use of DMA function.

Thus, since the scheduling of periodical tasks can be managed and performed separately from the scheduling of normal tasks, the embodiment described above can implement a periodical task execution apparatus and method which can reduce the overhead required for activation of the periodical tasks. The reduced overhead enables improvement in software performance and quality.

Part or all of the programs which perform the operations described above are recorded or stored as a computer program product on a portable medium such as a flexible disk or CD-ROM or on a storage medium such as a hard disk. Program code of the programs is read by a computer and part or all of the operations are performed. Alternatively, part or all of the programs can be distributed or provided via a communications network. By downloading the programs via the communications network and installing the programs on the computer or by installing the programs on the computer from a recording medium, the user can easily implement the periodical task execution apparatus according to the present invention.

The present invention is not limited to the embodiment described above, and various changes and alterations can be made without departing from the spirit and scope of the present invention.

What is claimed is:

1. A periodical task execution apparatus which executes one or more periodical tasks to be executed in a predetermined sequence, the periodical task execution apparatus comprising:
a comparison section configured to compare, when an activation request for any one of the one or more periodical tasks is made, priority of a task executing when the activation request is made and priority of a periodical task specified by the activation request;
a context register switching section configured to switch a register to be referred to for context to a periodical task context register which stores context of the periodical task specified by the activation request if it is found as a result of the comparison made by the comparison section that the priority of the periodical task specified by the activation request is higher than the priority of the executing task; and
a context setting section configured to load the periodical task context register with context of a periodical task to be executed next according to the predetermined sequence when execution of the periodical task specified by the activation request is ended.

2. The periodical task execution apparatus according to claim 1, wherein the executing task is any one of the one or more periodical tasks or a task other than the one or more periodical tasks.

3. The periodical task execution apparatus according to claim 1, wherein:
context of each of the one or more periodical tasks is stored in a predetermined storage area of a predetermined memory; and
the context setting section loads the periodical task context register with the context of the periodical task to be executed next by reading the context out of an appropriate storage area of the predetermined memory.

4. The periodical task execution apparatus according to claim 3, further comprising:
a first register configured to operate as the periodical task context register; and
a second register configured to store context of a task other than the one or more periodical tasks, wherein
context of the executing task is stored in the second register.

5. The periodical task execution apparatus according to claim 4, further comprising:
a third register configured to store the priority of the executing task; and
a fourth register configured to store the priority of the periodical task specified by the activation request, wherein
content of the fourth register is loaded into the third register when the priority of the periodical task specified by the activation request is higher than the priority of the executing task.

6. The periodical task execution apparatus according to claim 5, further comprising:
a fifth register configured to store an address of the predetermined memory storing the context of the periodical task to be executed next, wherein
the context setting section loads the periodical task context register with the context of the periodical task to be executed next according to the predetermined sequence with reference to the fifth register when the execution of the periodical task specified by the activation request is ended.

7. The periodical task execution apparatus according to claim 1, wherein when there are a plurality of predetermined sequences, a plurality of the periodical task context registers are provided, each corresponding to each of the plurality of predetermined sequences.

8. The periodical task execution apparatus according to claim 1, wherein when only the one or more periodical tasks are supposed to be executed on a processor, but none of the one or more periodical tasks is started up, the processor is changed into a sleep mode.

9. The periodical task execution apparatus according to claim 1, further comprising an exception handling section configured to perform predetermined exception handling if an activation request for another periodical task is made during execution of any one of the one or more periodical tasks.

10. The periodical task execution apparatus according to claim 9, wherein when an activation request for another periodical task is made, the predetermined exception handling continues execution of the executing task only once.

11. The periodical task execution apparatus according to claim 1, wherein the context setting section loads the periodical task context register with the context of the periodical task to be executed next according to the predetermined sequence using DMA.

12. The periodical task execution apparatus according to claim 1, wherein comparison and determination made by the comparison section are implemented by a hardware circuit.

13. The periodical task execution apparatus according to claim 1, wherein determination regarding an end of the periodical task is implemented by a hardware circuit.

14. The periodical task execution apparatus according to claim 1, wherein the end of execution of the periodical task is indicated by an instruction contained in the periodical task.

15. A periodical task execution method for executing one or more periodical tasks to be executed in a predetermined sequence, the periodical task execution method comprising:
comparing, when an activation request for any one of the one or more periodical tasks is made, priority of a task executing when the activation request is made and priority of a periodical task specified by the activation request;
switching a register to be referred to for context to a periodical task context register which stores context of the periodical task specified by the activation request if it is found as a result of the comparison that the priority of the periodical task specified by the activation request is higher than the priority of the executing task; and
loading the periodical task context register with context of a periodical task to be executed next according to the predetermined sequence when execution of the periodical task specified by the activation request is ended.

16. The periodical task execution method according to claim 15, wherein:
context of each of the one or more periodical tasks is stored in a predetermined storage area of a predetermined memory; and
the loading the periodical task context register is carried out such that the periodical task context register is loaded with the context of the periodical task to be executed next by reading the context out of an appropriate storage area of the predetermined memory.

17. The periodical task execution method according to claim 15, wherein when only the one or more periodical tasks are supposed to be executed on a processor, but none of the one or more periodical tasks is started up, the processor is changed into a sleep mode.

18. The periodical task execution method according to claim 15, further comprising performing predetermined exception handling if an activation request for another periodical task is made during execution of any one of the one or more periodical tasks.

19. The periodical task execution method according to claim 15, wherein the end of execution of the periodical task is indicated by an instruction contained in the periodical task.

20. A storage medium storing a program which makes a computer execute one or more periodical tasks to be executed in a predetermined sequence, the storage medium comprising:
a first code section configured to compare, when an activation request for any one of the one or more periodical tasks is made, priority of a task executing when the activation request is made and priority of a periodical task specified by the activation request;
a second code section configured to switch a register to be referred to for context to a periodical task context register which stores context of the periodical task specified by the activation request if it is found as a result of the comparison that the priority of the periodical task specified by the activation request is higher than the priority of the executing task; and
a third code section configured to load the periodical task context register with context of a periodical task to be executed next according to the predetermined sequence when execution of the periodical task specified by the activation request is ended.
